(19) United States
(12) Patent Application Publication
(10) Pub. No.: US 2007/0092366 A1
(43) Pub. Date: Apr. 26, 2007

(54) Forklift Attachment Utilizing Plow Mounts and Frame

(76) Inventor: Joseph M. Bose, Kalkaska, MI (US)

Correspondence Address: NORTHERN MICHIGAN PATENT LAW, PLC, 526 W. FOURTEENTH ST., #250, TRAVERSE CITY, MI, 49684, US

(21) Appl. No.: 11/163,582

(22) Filed: Oct. 24, 2005

(51) Int. Cl. B66F 9/18

(52) U.S. Cl. 414/607

(57) ABSTRACT

A forklift attachment is described which is designed to be used with a vehicle configured to receive a snowplow. Such a vehicle typically includes a snowplow frame with a pair of spaced apart attachment points interconnected with the structure of the vehicle and a plow lifting arm that is movable with respect to the attachment points. Such a vehicle also would have a source of pressurized hydraulic fluid. The forklift attachment includes a base with a pair of vertical members and at least one interconnection arm which is designed to attach the base to one or more of the attachment points of the plow frame on the vehicle. A forklift rack is supported by the vertical members of the base for vertical movement. A hydraulic actuator is positioned between the rack and the base so as to move the rack upwardly and downwardly. A coupler interconnects the hydraulic actuator with a source of pressurized hydraulic fluid on the vehicle. Lifting members, such as forklift tines, interconnect with the forklift rack to allow the forklift attachment to lift any of a variety of items.

### FIELD OF THE INVENTION

The present invention relates generally to material handling mechanisms and, more specifically, to a forklift attachment for a vehicle that is configured to receive a plow.

### BACKGROUND AND DESCRIPTION OF RELATED ART

Forklifts are well known machines that are used to lift and move various types of materials. A forklift typically consists of some type of multi-wheeled vehicle with a pair of lifting tines mounted to a lifting apparatus on the front of the vehicle. A forklift is particularly well suited to lifting and maneuvering articles that are positioned on pallets. A pallet is typically a low platform with spaces for accepting the tines of a forklift. Articles to be transported may be placed on the platform of the pallet. The forklift is maneuvered such that the lifting tines are positioned below an article to be lifted and then the lifting apparatus lifts the tines, along with the material to be moved, upwardly. Then, the forklift is moved to another location using the wheels and the article being transported is placed on the ground or on some type of shelf.

The vehicle portion of a forklift is typically very heavy, to counteract loads lifted by the lifting tines. The forklift is also typically compact and highly maneuverable so that it may be easily positioned while lifting and transporting various materials. Forklifts are commonly used to move materials around in warehouses and factories. For example, supplies for a typical machine tool may be stored in a warehouse until needed. When needed, a forklift will locate the materials in the warehouse. The materials may be located high above the ground on some type of shelving, or right on the ground. The forklift will pick up the material, lift or lower it to a safe height, and then relocate the material to the location where it is needed. Forklifts for use in factory and warehouse settings are typically single purpose, specialized, very expensive machines. To justify the purchase price, storage, and maintenance of such a forklift requires that it be used frequently. Such is the case in factories and warehouses where materials continuously have to be relocated from place to place. Many small businesses and individuals would periodically find a forklift to be a highly useful item. However, these companies and individuals seldom can justify the expense and storage associated with owning and operating a single purpose forklift. Therefore, there is a need for less expensive machines or attachments for existing machines that provide the utility of a forklift for occasional use.

There have been numerous attempts to provide forklift attachments for existing vehicles such as trucks and tractors. Many of the persons or companies that would benefit from the use of a forklift already own a vehicle such as a tractor or a truck. There have been numerous attempts to provide attachments for vehicles such as these that provide some of the utility of a single purpose forklift without the associated expense and storage requirements. However, these devices have numerous shortcomings. Generally, they are expensive, heavy, and complicated, and require a complicated installation procedure after which the attachment is not easily removed. U.S. Pat. No. 2,707,063 to Gran et al.; U.S. Pat. No. 2,754,020 to Dunn et al.; U.S. Pat. No. 3,672,525 to Schaedler; U.S. Pat. No. 3,045,853 to Card, Sr.; U.S. Pat. No. 3,521,780 to Cook; U.S. Pat. No. 4,394,107 to Siebert; U.S. Pat. No. 4,640,662 to Spellman, Jr.; and U.S. Pat. No. 5,590,998 to Wilcox disclose examples of lifting or forklift attachments for existing vehicles. In each of these patents, the lifting or forklift device is complicated in the way it mounts to the vehicle. They also typically require significant adaptation of the existing vehicle in order that the vehicle may be used with the lifting or forklift attachment.

### BRIEF SUMMARY OF THE INVENTION

The present invention takes advantage of the fact that many individuals and companies own vehicles, such as four wheel drive pickups, which are configured to accept snowplow blades for removing snow in the winter. Vehicles configured for accepting a snowplow typically include a snowplow frame which has a pair of spaced apart attachment points interconnected with the structure or frame of the vehicle. A snowplow frame also typically includes a plow lifting arm that is movable with respect to the attachment points. Finally, vehicles configured for accepting a snowplow typically include a source of pressurized hydraulic fluid, such as a hydraulic pump. The accessories that configure the vehicle for use with a snowplow are typically only used during the winter when snow must be plowed. The rest of the year, these components are unused and may, in fact, be removed from the vehicle. The present invention takes advantage of these components to attach and operate a forklift attachment.

The forklift attachment according to the present invention includes a base which has a pair of vertical members and at least one interconnection arm configured to attach the base to one or more of the attachment points of the plow frame. The attachment also includes a forklift rack which is supported by the vertical members of the base so that the forklift rack may be moved vertically. A hydraulic actuator is disposed between the base and the forklift rack to move the rack upwardly and downwardly. A coupler is provided for interconnecting the hydraulic actuator with the source of pressurized hydraulic fluid on the vehicle. Lifting members, such as forklift tines, are interconnected with the forklift rack for lifting any of a variety of items.

By attaching a forklift attachment according to the present invention to a vehicle that is configured to receive a snowplow, such a vehicle may be used like a forklift to lift and relocate a variety of materials.

### BRIEF DESCRIPTION OF THE DRAWINGS

FIG. 1 is a perspective view of a forklift attachment according to the present invention as installed on a vehicle with the forklift rack positioned in the highest vertical position.

FIG. 2 is a side cross-sectional view of the forklift attachment of FIG. 1 taken along lines 2-2, with the forklift rack in the lowest vertical position.

FIG. 3 is a top plan view of the forklift attachment of FIG. 1.

FIG. 4 is a front elevational view of the forklift attachment of FIG. 1 with the forklift rack in the lowest vertical position.

FIG. 5 is a detailed view of a portion of a forklift rack with an optional extension for supporting the forklift tines in a folded position.

FIG. 6 is a detailed view of the forklift rack and extension of FIG. 5 with two forklift tines supported on the extension and folded against the forklift rack for storage and transportation.

### DETAILED DESCRIPTION OF THE INVENTION

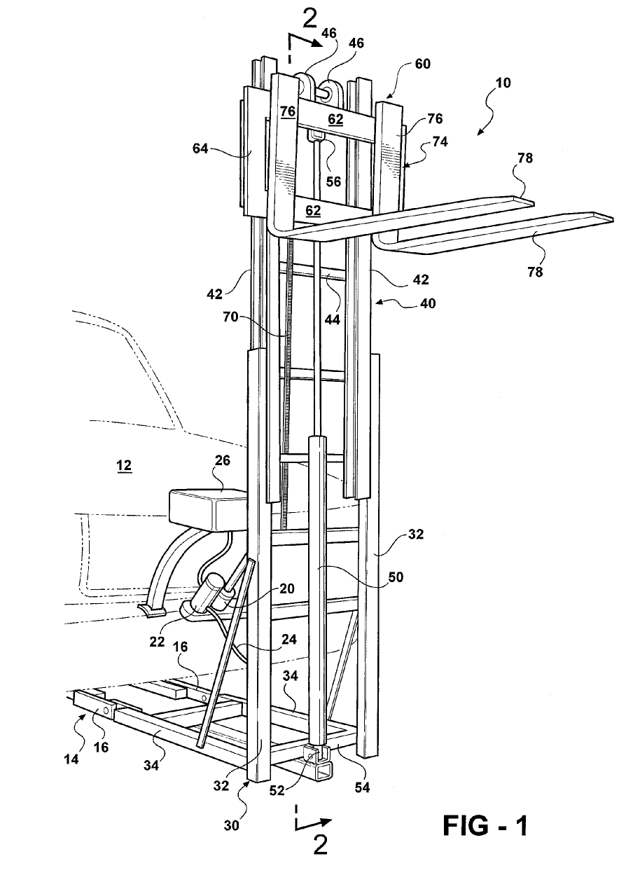

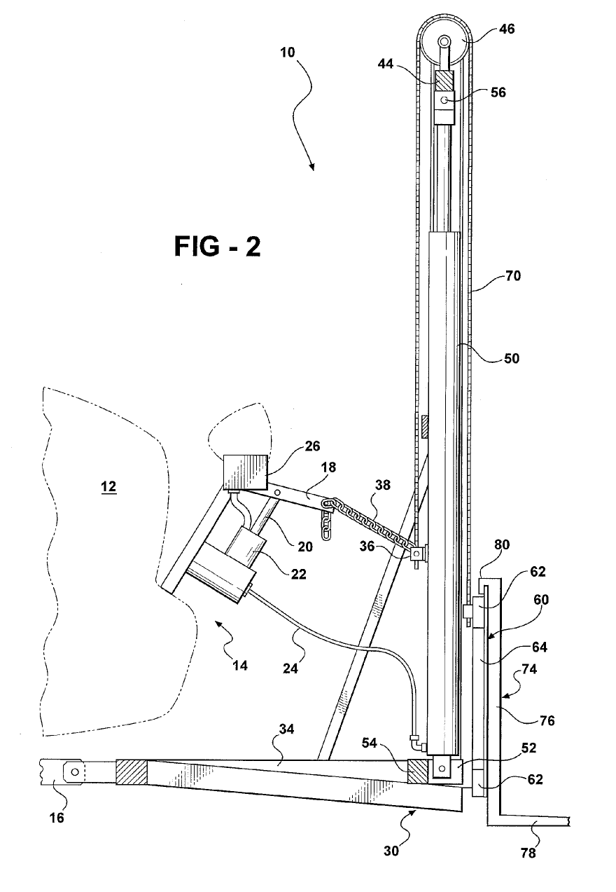

Referring to FIGS. 1-4, a forklift attachment according to the present invention is generally shown at 10. In FIGS. 1 and 2, the forklift attachment is shown attached to a vehicle 12 which is configured to receive a snowplow. Typically, vehicles 12 which have been configured for use with a snowplow have a snowplow frame 14 of some type mounted to the vehicle. The snowplow frame 14 may be of various types and is designed to interconnect with and control a snowplow. A snowplow frame 14 generally includes a pair of attachment points 16 which are positioned low on the front of the vehicle 12 and interconnected with the frame of the vehicle. These attachment points are used to interconnect with the snowplow so that forces are transmitted between the frame of the vehicle and the snowplow. The snowplow frame 14 also typically includes a plow lifting arm 18 which extends outwardly from the front end of the vehicle 12. One end of the plow lifting arm 18 is generally pivotally interconnected with the snow plow frame 14, the other end of the snowplow lifting arm 18 being movable upwardly and downwardly relative to the attachment points 16. Typically, the snowplow lifting arm 18 is pivoted upwardly and downwardly by a hydraulic cylinder 20, as shown. The snowplow lifting arm 18 normally acts to lift and lower the snowplow during plowing activities.

The plow frame also typically includes a source of pressurized hydraulic fluid such as hydraulic pump 22. Alternatively, a hydraulic pump may be mounted under the hood of the vehicle, or dispensed with entirely if the vehicle has an alternative source of hydraulic power. The hydraulic pump 22 powers the hydraulic cylinder 20 as well as an additional actuator used to tilt a snowplow side to side. This actuator is not shown in the drawings, as it is typically mounted to the snowplow and removed from the vehicle with the snowplow. A hydraulic line 24 is shown in FIG. 2 which would normally be attached to the second hydraulic cylinder on the snowplow.

The forklift attachment 10 is designed to interconnect with the attachment points 16, the snowplow lifting arm 18, and the source of hydraulic fluid, such as hydraulic line 24, and to provide the functions of a typical forklift. For ease of description, the forklift attachment 10 will be described in its installed position on the vehicle 12, as shown in the figures. Therefore, descriptions such as horizontal and vertical refer to positions when the forklift attachment is installed on the vehicle. Obviously, the forklift attachment 10 may be removed from the vehicle 12 and stored in any of a variety of positions.

The forklift attachment 10 includes a base 30. When viewed from the side, as in FIG. 2, the base 30 is generally L-shaped. A pair of spaced apart vertical members 32 extend generally upwardly and downwardly at a position spaced from the front of the vehicle 12. An interconnection arm 34 extends rearwardly from the bottom end of each vertical member 32 and is configured for interconnecting the base 30 with the attachment points 16 on the vehicle 12. Typically, the attachment points 16 consist of flat pieces of steel with a hole therethrough. In order to interconnect with these attachment points 16, the interconnection arms 34 include similar rearwardly extending flat pieces of metal with a hole therethrough. A pin or a bolt may then be used to interconnect the attachment points 16 with the rearwardmost end of the interconnection arm 34. The interconnection between the attachment points 16 and the interconnection arm 34 defines a horizontal pivot axis so that the base 30 may be tilted towards and away from the vehicle 12 about an axis passing through the interconnection points 16.

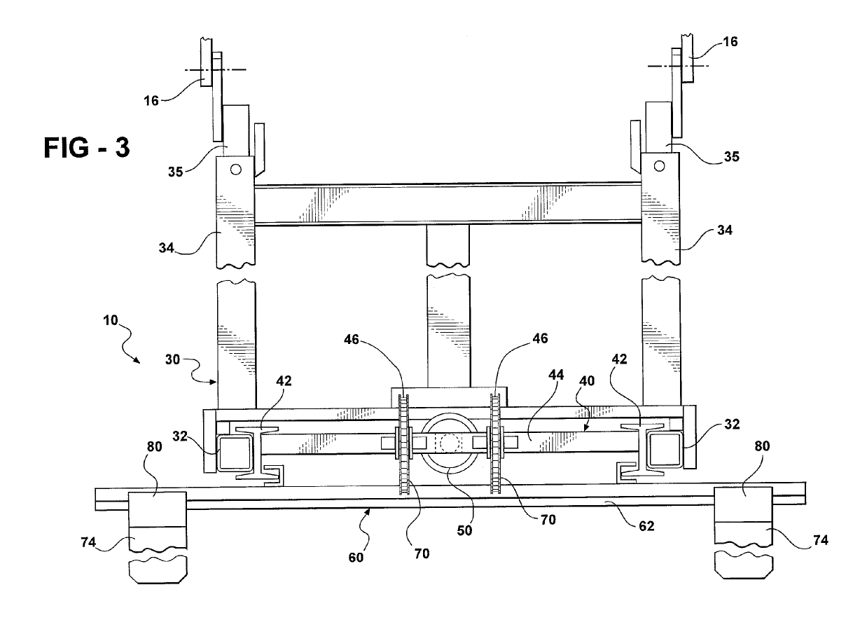

As shown in FIG. 3, adaptors 35 may be included for adapting the rearward ends of the interconnection arms 34 for use with attachment points 17 which are spaced differently than shown in FIG. 1. The interconnection points 16 on a vehicle adapted for use with a snowplow may be spaced apart by different distances. To accommodate this variation, adaptors 35 slide into the rearward ends of the interconnection arms 34 and provide flat pieces of metal that are spaced further apart for use with the wider spaced attachment points 16. As will be clear to those of skill in the art, other types of adaptors may be used for adapting the interconnection arms 34 to the attachment points 16. Alternatively, base 30 may be provided in various widths to accommodate different spacing of attachment points 16.

For strength and stiffness, the base 30 preferably includes a variety of cross and angular braces, as shown in the various figures. The base 30 also includes a link interconnecting area 36 on the back side of a cross brace interconnecting the vertical members 32. A chain 38 or some other type of flexible member preferably interconnects the link interconnecting area 36 with the outer end of the plow lifting arm 18. This arrangement allows the plow lifting arm 18 to control the forward and backward tilt of the base 30. As the plow lifting arm 18 is raised, the chain 38 pulls the link interconnecting area 36, and therefore the base 30, rearwardly thereby tilting the base 30 upwardly and rearwardly towards the vehicle 12. Lowering the plow lifting arm 18 reverses this process.

As shown, the vertical members 32 and interconnection arms 34 are constructed of box tube steel. However, other arrangements may be made, as will be clear to those of skill in the art.

As best shown in FIGS. 1 and 3, the forklift attachment 10 also preferably includes a movable intermediate member 40 which is supported by the vertical members 32 of the base 30 for vertical movement. The intermediate member 40 has a pair of vertical H-shaped rails 42 which are interconnected by a series of horizontal braces 44. Because the vertical rails 42 are H-shaped, they have sideways facing open sections that are somewhat C-shaped. This configuration allows the sideways facing, open sections of the vertical rails 42 to mate with and engage inner surfaces of the vertical members 32 of the base 30 and slide upwardly and downwardly thereon. Obviously, other arrangements for supporting the intermediate member 40 on the base 30 are also possible. For example, linear bearings could be used. The intermediate member 40 also preferably includes a pair of rotationally mounted sprockets 46 which are supported on the uppermost horizontal brace 44.

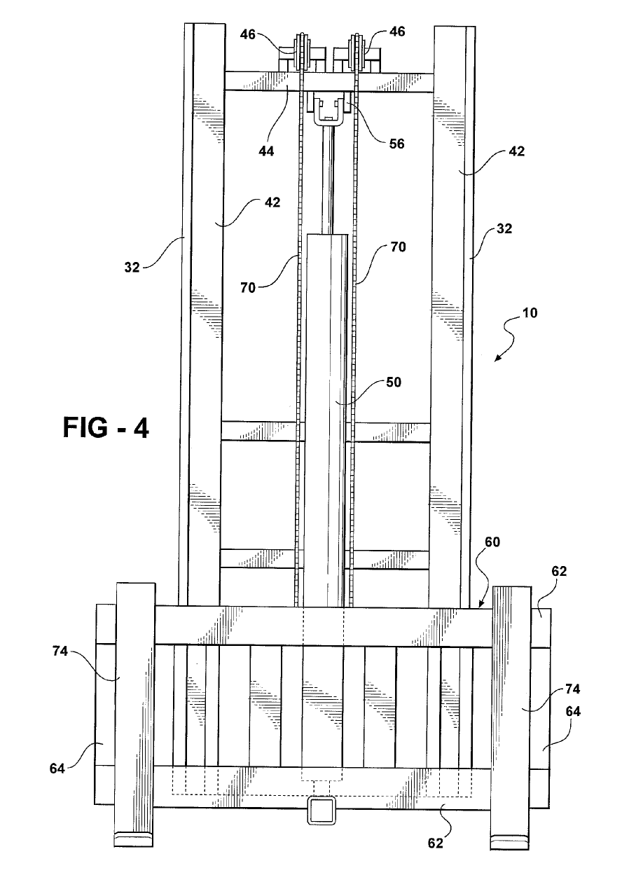

A large hydraulic actuator 50 is positioned vertically and is disposed between the base 30 and the intermediate member 40 so as to cause vertical movement therebetween. Specifically, the base 30 includes a cylinder mount 52 adjacent the lower end of the vertical members and about halfway therebetween on a horizontal brace 54. The hydraulic actuator 50 extends upwardly therefrom with its other end interconnecting with a second cylinder mount 56 which is fixed to the underside of the topmost horizontal brace 44 of the intermediate member 40. The forklift attachment 10 also includes a coupler for interconnecting the hydraulic actuator 50 with the source of hydraulic fluid on the vehicle 12. In the illustrated embodiment, the coupler takes the form of the hydraulic line 24 which interconnects the pump 22 with the hydraulic actuator 50. Thereby, the pump 22 can provide pressurized hydraulic fluid to the hydraulic actuator 50 and change the position of the intermediate member 40 relative to the base 30. FIG. 1 shows the hydraulic cylinder completely extended with the intermediate member 40 moved to its topmost position. FIGS. 2 and 4 show the hydraulic actuator in a lowered position with the intermediate member 40 at a lowered position. As will be clear to those of skill in the art, the hydraulic actuator 50 may be arranged in other ways so as to cause relative movement between the base 30 and the intermediate member 40.

A forklift rack 60 is supported by the vertical rails of the intermediate member 40 for upwardly and downwardly vertical movement. As shown, the forklift rack 60 includes a pair of generally horizontal rails 62 interconnected by a pair of vertical braces 64. The horizontal rails 62 are spaced apart by a short distance and are interconnected by the vertical braces 64 adjacent their ends. Mounted to the back side of the forklift rack 60 are a pair of vertical sideways facing C-shaped channels which engage an inner flange of each of the vertical rails of the intermediate member 40. This arrangement allows the forklift rack 60 to slide upwardly and downwardly on the vertical rails 42 of the intermediate member 40.

In order to raise and lower the forklift rack 60, two lifting chains 70 extend from the base 30, up and over the sprockets 46 and interconnect with the forklift rack 60. This arrangement causes the forklift rack 60 to be pulled upwardly by the lifting chains 70 as the intermediate member 40 is pushed upwardly by the hydraulic actuator 50. As shown, one end of each of the lifting chains 70 is secured to the uppermost horizontal rail 62 of the forklift rack. The other end of each of the chains 70 interconnects with the upper side of the link interconnecting area 36 on the back side of the vertical members 32 of the base 30. In between their ends, the chains 70 pass over the sprockets 46 which are mounted to the upper end of the intermediate member 40. As the hydraulic actuator 50 pushes the intermediate member 40 upwardly, the lifting chains 70 cause the forklift rack 60 to move approximately twice the distance as the intermediate member 40 is moved by the hydraulic actuator allowing the forklift rack 60 to be raised and lowered twice the distance as the stroke of the hydraulic actuator. Alternatively, the actuator 50 could directly actuate the forklift rack 60 directly and the chain could be eliminated. Other arrangements are also possible.

As with a standard forklift, forklift tines 74 are supported on the forklift rack 60 and may be used to lift and transport a variety of objects. Each forklift tine 74 has a vertical portion 76 with a hook 80 on its rearward side for engaging the uppermost horizontal rail 62 of the forklift rack 60. Each tine 74 also includes a horizontal portion which extends perpendicularly forwardly from the bottom end of the vertical portion 76. It is this horizontal portion 78 which is positioned under an item to be lifted. The forklift tines 74 may be slid sideways on the horizontal rails 62 of the forklift rack so as to accommodate a variety of items to be lifted. Obviously, other types of lifting members may be substituted for the forklift tine 74 to accomplish other types of jobs.

As discussed previously, the hydraulic pump 22 is used to provide pressurized hydraulic fluid to the hydraulic actuator 50. However, the hydraulic actuator 50 is much larger than the hydraulic actuator which would normally be used to tilt a snowplow blade and therefore requires significantly more fluid to operate. Therefore, an additional reservoir 26 is preferably added to the snowplow frame 14 so as to increase the capacity of the pump 22.

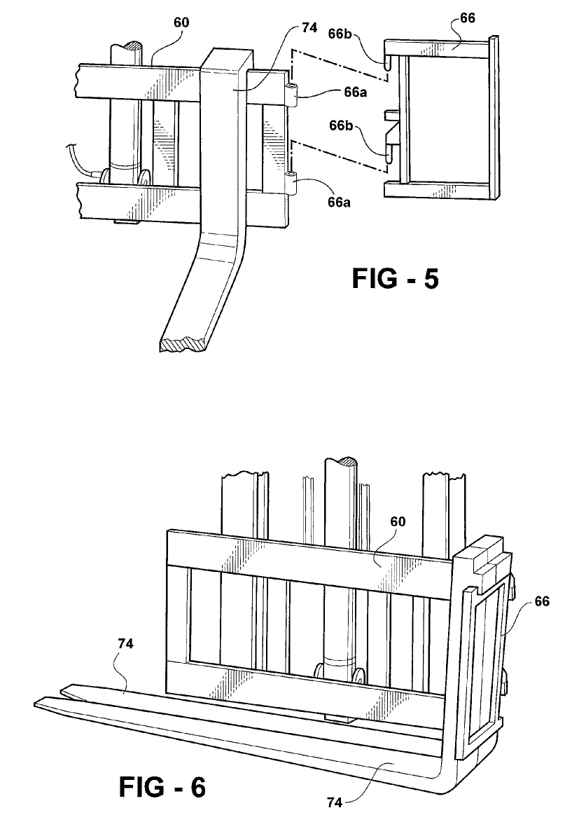

Referring now to FIGS. 5 and 6, an additional aspect of the present invention will be discussed. As shown in FIG. 1, the forklift tines 74 extend forwardly from the front of the vehicle 12. This is ideal for lifting objects but inconvenient if the vehicle 12 is to be used or transported while not lifting items. As shown in FIGS. 5 and 6, the forklift rack preferably includes an extension piece 66 which is pivotally connected to one side of the forklift rack 60, for example with the illustrated socket and pin structure 66a and 66b. With the extension piece 66 in place, the forklift tines 74 may be slipped sideways onto the extension piece 66 and the extension piece 66 pivoted so as to fold the horizontal portion 78 of the tines 74 against the forklift rack 60 for transport, as shown in FIG. 6.

As will be clear to those of skill in the art, the previously disclosed preferred embodiment of the forklift attachment according to the present invention may be altered in various ways without departing from the intent or teachings of the present invention. For example, a simpler version of the forklift attachment may be constructed by dispensing with the intermediate member 40. In this case, the forklift rack 60 would interconnect with the vertical members 32 of the base 30 so that the rack may move upwardly and downwardly on these vertical members. A hydraulic actuator may then interconnect between the rack and the base so that it would directly actuate the rack. This variation creates a simpler attachment though it would typically have less lifting range than the preferred embodiment. The forklift attachment may also be enhanced through the addition of other options. For example, some special purpose forklifts include actuators for moving the forklift tines side to side for positioning an item or for improved lifting. Obviously, additional actuators could be included with the forklift attachment to provide functions such as these. Other variations and modifications will also be clear to those of skill in the art. Therefore, the preceding description and drawings should be interpreted broadly. It is the following claims, including all equivalents, which define the scope of the present invention.

1. A forklift attachment for a vehicle configured to receive a snow plow, the vehicle having a snow plow frame of the type including a pair of spaced apart attachment points interconnected with the structure of the vehicle and a plow lifting arm that is movable with respect to the attachment points, the vehicle also having a source of pressurized hydraulic fluid for moving the snow plow lifting arm, said forklift attachment comprising:
a generally L-shaped vertical lift base having a pair of vertical members and at least one horizontal interconnection arm configured for removably attaching said base to the attachment points of the plow frame on a rigid horizontal pivot axis such that the vertical lift base is cantilevered in tilting fashion from the snow plow attachment points by the at least one interconnection arm;
a link for interconnecting the vertical members to the snow plow lifting arm above the snow plow attachment points such that the vertical lift base is supported on the snow plow attachment points through the link and such that operation of the snow plow lifting arm tilts the vertical lift base on the snow plow attachment points through the link;
a forklift rack supported by said vertical members of said vertical lift base for vertical lifting movement relative to the vertical lift base;
a hydraulic lift actuator on the vertical lift base disposed between said vertical lift base and said forklift rack for vertically lifting said rack upwardly and downwardly relative to the vertical lift base;
a hydraulic coupler for hydraulically interconnecting said hydraulic lift actuator to the source of pressurized hydraulic fluid on the vehicle;
a lifting member interconnected with said forklift rack for lifting any of a variety of items.

2. (canceled)

3. The forklift attachment according to claim 1, wherein said lifting member comprises a pair of forklift tines.

4. (canceled)

5. The forklift attachment according to claim 1, further comprising a movable intermediate member supported on said vertical members of said base for vertical movement, said intermediate member having a pair of vertical rails, said forklift rack being supported by said vertical rails of said intermediate member for vertical movement.

6. The forklift attachment according to claim 1, further comprising an extension piece removably connected to one side of said forklift rack in pivoting fashion, said lifting member movable sideways from said forklift rack to a non-lifting position on said extension piece so that said lifting member may be pivoted to a storage position against a front face of said forklift rack.

7. The forklift attachment according to claim 1, wherein said at least one interconnection arm comprises a pair of interconnection arms.

8. A forklift attachment for a vehicle having a snow plow frame of the type including a pair of spaced apart attachment points interconnected with the structure of the vehicle, a plow lifting arm that is movable with respect to the attachment points, and a source of pressurized hydraulic fluid for moving the snow plow lifting arm, said forklift attachment comprising:
a generally L-shaped vertical lift base having a pair of vertical members and at least one horizontal interconnection arm configured for removably attaching said base to the attachment points of the plow frame on a horizontal pivot axis such that the vertical lift base is cantilevered in tilting fashion from the snow plow attachment points by the at least one interconnection arm;
a movable intermediate member supported by the vertical members of said base for vertical movement, said intermediate member having a pair of vertical rails and a sprocket;
a forklift rack supported by the vertical rails of the intermediate member for vertical movement;
a hydraulic lift actuator on the vertical lift base disposed between said base and said intermediate member for vertically lifting said intermediate member upwardly and downwardly;
a hydraulic coupler for interconnecting said actuator to the source of pressurized hydraulic fluid;
a lifting chain extending from said base, over said sprocket on said intermediate member, and to said forklift rack, such that when said hydraulic actuator moves said intermediate member upwardly, said chain causes said forklift rack to move upwardly with respect to said intermediate member; and
a lifting member interconnected with said forklift rack for lifting any of a variety of items; and,
a link interconnecting said base with the plow lifting arm such that movement of the plow lifting arm causes said base to tilt on the snow plow attachment points.

9. (canceled)

10. The forklift attachment according to claim 8, wherein said lifting member comprises a pair of forklift tines.

11. The forklift attachment according to claim 1, wherein said interconnection arm is generally perpendicular to said vertical members such that said base is L-shaped.

12. The forklift attachment according to claim 8, further comprising a second sprocket on said intermediate member and a second lifting chain extending from said base, over said second sprocket, and to said forklift rack.

13. The forklift attachment according to claim 8, further comprising an extension piece pivotally supported by said forklift rack, said lifting member movable to said extension piece so that said lifting member may be pivoted relative to said forklift rack.

14. The forklift attachment according to claim 8, wherein said at least one interconnection arm comprises a pair of interconnection arms.
